(19) United States
(12) Patent Application Publication
(10) Pub. No.: US 2021/0406472 A1
(43) Pub. Date: Dec. 30, 2021

(54) NAMED-ENTITY CLASSIFICATION APPARATUS AND NAMED-ENTITY CLASSIFICATION METHOD

(71) Applicant: Hitachi, Ltd., Tokyo (JP)

(72) Inventors: Daiba KATO, Tokyo (JP); Michiko TANAKA, Tokyo (JP)

(21) Appl. No.: 17/198,327

(22) Filed: Mar. 11, 2021

(30) Foreign Application Priority Data
Jun. 30, 2020 (JP) 2020-112732

(51) Int. Cl. G06F 40/295

(52) U.S. Cl. CPC G06F 40/295

(57) ABSTRACT

A named-entity classification apparatus including an information processing apparatus, is configured to classify a plurality of named entities extracted from document information into categories by using an inference model, receive, from a user, input of correctness information indicating whether each of the named entities has been classified into a category correctly, correct weights of feature amounts that the inference model uses in the classification based on the received correctness information, and retrain the inference model based on the weights after the correction.

### CROSS-REFERENCE TO RELATED APPLICATION

This application claims priority pursuant to Japanese patent application No. 2020-112732, filed on Jun. 30, 2020, the entire disclosure of which is incorporated herein by reference.

### BACKGROUND

### Technical Field

The present invention relates to a named-entity classification apparatus and a named-entity classification method.

### Related Art

Japanese Patent Application Laid-open Publication No. 2013-246795 (hereinafter referred to as patent document 1) discloses a named-entity classification apparatus configured for the purpose to make it possible to extract labeled named entities accurately even if the categories for named entities have detailed category classifications. The named-entity classification apparatus calculates, based on an input document subjected to morphological analysis, for each word in the input document, characteristics indicating features related to information within the word and features related to contexts around the word. Based on the characteristics of each word and a pre-trained recognition model for recognizing based on the characteristics of the word whether the word is a named entity, which is expression of a named object, with an attached label indicating the category of the named entity, the named-entity classification apparatus recognizes whether each word in the input document is a named entity with a label attached, and extracts named entities with the labels attached from the input document.

Japanese Patent Application Laid-open Publication No. 2017-058816 (hereinafter referred to as patent document 2) discloses an information extraction apparatus configured for the purpose to extract appropriate characteristics (clue words or the like) for the characteristics used for making extraction rules that are used when information desired by the user is extracted from data. The information extraction device extracts, from a plurality of first information pieces each including target information on a target to which information is to be provided and a result of processing the target information by the operator, a plurality of second teacher information pieces including the same target information and a different processing result, and extracts clue information leading to a different processing result from the difference between the plurality of second teacher information pieces.

In recent years, along with increase in the amount of document information stored in various parts of society, such as companies, organizations, and the like, there has been increasing demand for extracting named entities from document information, using a machine learning model (hereinafter referred to as an “inference model”) and classifying the extracted named entities into categories to utilize them as a dictionary or the like.

Here, in order to classify named entities extracted from document information into appropriate categories, it is necessary to improve the inference accuracy of the inference model. In general, as for training of an inference model used for classification of named entities, a person familiar with the field of the named entities (a subject matter expert: SME) performs correct-or-incorrect determination on the classification results, and also a person having expert knowledge on data analysis (a data scientist: DS) identifies feature amounts (feature amounts used in the inference model) that affected the results of the correct-or-incorrect determination and restructures the inference model. In short, to improve the inference accuracy of an inference model, the manual work by the SME and the work by the DS both are indispensable, and this causes a problem of heavy workloads. In addition, work places (domains) seeking to effectively use named entities classified in categories as a dictionary or the like desire a system to be provided that enables accurate classification of named entities only with an SME without relying on a DS. Each of the techniques described in the above patent documents 1 and 2 absolutely requires both the manual work by an SME and the work by a DS.

### SUMMARY

The present invention has been made in light of the above background, and an object thereof is to provide a named-entity classification apparatus and a named-entity classification method that make it possible to classify named entities into categories efficiently and with high accuracy.

An aspect of the present invention to achieve the above object is a named-entity classification apparatus comprising an information processing apparatus, the named-entity classification apparatus configured to classify a plurality of named entities extracted from document information into categories by using an inference model, receive, from a user, input of correctness information indicating whether each of the named entities has been classified into a category correctly, correct weights of feature amounts that the inference model uses in the classification based on the received correctness information, and retrain the inference model based on the weights after the correction.

The present invention makes it possible to classify named entities into categories efficiently with high accuracy.

### BRIEF DESCRIPTION OF THE DRAWINGS

FIG. 1 is a diagram illustrating main functions included in a named-entity classification apparatus;

FIG. 2 shows an example of hardware of an information processing apparatus used to implement the named-entity classification apparatus;

FIG. 3 shows examples of document information;

FIG. 4 shows examples of inference-model parameters;

FIG. 5 shows an example of an inference result table;

FIG. 6 shows an example of a correct-incorrect determination table;

FIG. 7 shows an example of a determination-result-basis feature-amount table;

FIG. 8 shows an example of a feature-amount analysis table;

FIG. 9 shows examples of corrected inference-model parameters;

FIG. 10 shows an example of a named-entity dictionary;

FIG. 11 is a flowchart for explaining a named-entity-dictionary generation process;

FIG. 12 is a flowchart for explaining a priority assigning process;

FIG. 13 is a flowchart for explaining a feature-amount correction process;

FIG. 14 is a flowchart for explaining an examination process;

FIG. 15 is a schematic diagram for explaining the named-entity-dictionary generation process; and

FIG. 16 shows an example of an information-setting check screen.

### DESCRIPTION OF EMBODIMENTS

Problems disclosed in the present application and solutions for the problems other than the above will be made clear from the present embodiments and the drawings.

Hereinafter, an embodiment of the present invention will be described with reference to the drawings. The following description and the drawings are examples for illustrating the present invention and thus include omission and simplified description as appropriate to make description clearer. The present invention can be implemented in other various embodiments. Unless otherwise specified, each constituent may be singular or plural.

In the following description, the letter “S” prefixed to a code indicates that the code means a process step. In the following description, although the expressions “table” and “information” are used to explain various kinds of information (data), various kinds of information may be expressed with data structures other than these. Although in the explanation about identification information, expressions such as “identifier”, “ID”, and the like are used as appropriate, these expressions are interchangeable with one another.

In addition, the term “document” used in the following description means data that expresses the document in a specified electronic format such as text data. The term “word” used in the following description means a named entity extracted by an information processing apparatus. In the following description, named entities are a general term that refers to specific things such as person names, location names, and the like. For example, “engineer” and “Tokyo” are named entities about “person” and “location”. In this case, “person” and “location” into which named entities are classified are referred to as “categories”.

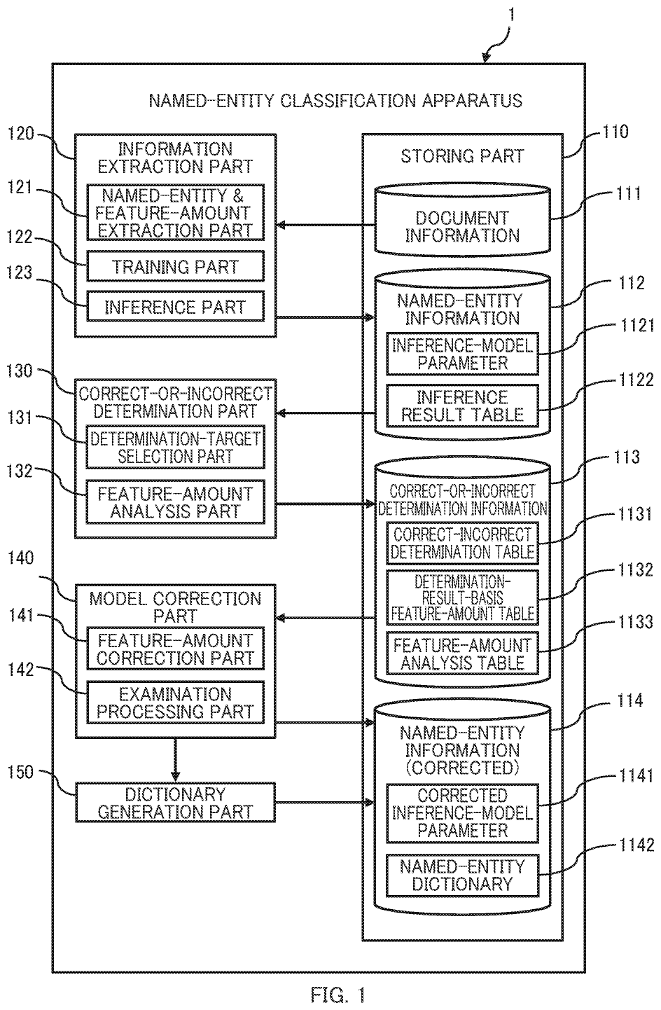

FIG. 1 illustrates main functions included in a named-entity classification apparatus 1 which is an information processing apparatus that is described as an embodiment of the present invention. The named-entity classification apparatus 1, when named entities extracted from document information are categorized into preset categories, assists the work of the user (a person familiar with the fields of the named entities (SME: subject matter expert) or the like) and makes it possible to classify the named entities into categories efficiently and appropriately. In the case where the named-entity classification apparatus 1 is used to classify named entities into categories, work by a person having expert knowledge on data analysis (DS: data scientist) is not necessary in principle.

As illustrated in FIG. 1, the named-entity classification apparatus 1 includes the functions of a storing part 110, an information extraction part 120, a correct-or-incorrect determination part 130, a model correction part 140, and a dictionary generation part 150.

The storing part 110 stores the following information (data): document information 111, named-entity information 112, correct-or-incorrect determination information 113, and named-entity information (corrected) 114. The storing part 110 stores these kinds of information (data), for example, in tables of databases provided by database management systems (DBMSs) or files provided by file systems.

The document information 111 includes a plurality of documents from which named entities are extracted. The contents of the document information 111 are not limited to any specific ones. For example, the document information 111 may include documents inputted by the users or information obtained via communication networks such as the Internet.

The named-entity information 112 concerns named entities extracted by the information extraction part 120 and feature amounts used when the named entities are classified into categories, and includes and inference-model parameters 1121, and inference result tables 1122.

The correct-or-incorrect determination information 113 is information (hereinafter referred to as “correctness information”) concerning the results of determinations whether the category into which each named entity has been classified is correct or incorrect (hereinafter referred to as “correct-or-incorrect determinations”), and includes a correct-or-incorrect determination table 1131, determination-result-basis feature-amount tables 1132, and feature-amount analysis tables 1133.

The named-entity information (corrected) 114 is information concerning the results obtained by correcting the named-entity information 112 based on the correct-or-incorrect determination information 113, and includes corrected inference-model parameters 1141, and a named-entity dictionary 1142.

The information extraction part 120 illustrated in FIG. 1 includes the functions of a named-entity & feature-amount extraction part 121, a training part 122, and an inference part 123. The named-entity & feature-amount extraction part 121 executes morphological analysis on documents in the document information 111 to extract named entities and feature amounts and classifies the extracted named entities into categories. The training part 122 trains an inference model which is a machine learning model using the above feature amounts and included in the inference part 123, and generates the inference-model parameters 1121. The inference part 123 uses the above inference model to classify the named entities extracted by the named-entity & feature-amount extraction part 121 into categories and generates the inference result table 1122.

The correct-or-incorrect determination part 130 includes a determination-target selection part 131, and a feature-amount analysis part 132. The determination-target selection part 131 selects named entities for which input of correctness information is to be received from the user, out of the named entities extracted by the named-entity & feature-amount extraction part 121. The feature-amount analysis part 132 generates the correct-or-incorrect determination information 113 based on the correctness information inputted by the user on the named entities.

The model correction part 140 includes a feature-amount correction part 141 and an examination processing part 142. The feature-amount correction part 141 corrects the weights of feature amounts based on the correct-or-incorrect determination information 113. The examination processing part 142 generates the distribution of the probability, after the weights of feature amounts are corrected, indicating the suitability of a category (hereinafter also referred to as “category probability”) into which a named entity has been classified, and examines, based on the generated distribution, whether it is possible to determine a threshold used for the determination whether each named entity can be adopted into the named-entity dictionary 1142.

The dictionary generation part 150 generates the named-entity information (corrected) 114. The dictionary generation part 150, after the model correction part 140 corrects the weights of feature amounts and changes category probabilities, compares the category probability of each named entity with a threshold described later, selects named entities to be registered into the named-entity dictionary 1142, and registers the selected named entities into the named-entity dictionary.

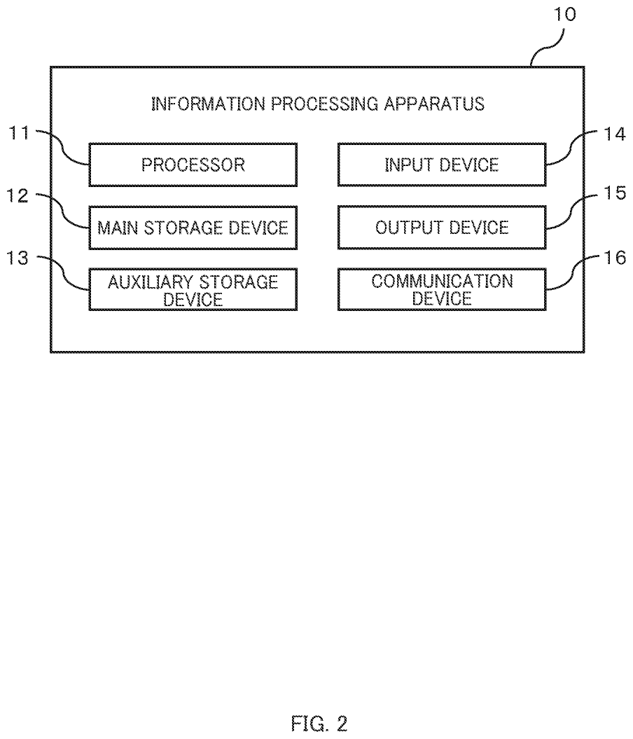

FIG. 2 illustrates an example of hardware of the information processing apparatus used for implementing the named-entity classification apparatus 10. The illustrated information processing apparatus 10 includes a processor 11, a main storage device 12, an auxiliary storage device 13, an input device 14, an output device 15, and a communication device 16. Note that all or part of the information processing apparatus 10 may be implemented, for example, by using virtual information processing resources provided using technologies such as virtualization technology and processing space separation technology, such as virtual servers provided in cloud systems. In addition, all or some of the functions provided by the information processing apparatus 10 may be implemented by, for example, services provided by cloud systems via application programming interfaces (APIs) or the like. Further, the named-entity classification apparatus 1 may be implemented by using a plurality of information processing apparatuses 10 that are communicably coupled.

In FIG. 2, the processor 11 includes, for example, a central processing unit (CPU), a micro processing unit (MPU), a graphics processing unit (GPU), a field programmable gate array (FPGA), an application specific integrated circuit (ASIC), an artificial intelligence (AI) chip, or the like.

The main storage device 12 stores programs and data and is, for example, read only memory (ROM), random access memory (RAM), nonvolatile memory (nonvolatile RAM (NVRAM), or the like.

The auxiliary storage device 13 is, for example, a hard disk drive, a solid state drive (SSD), an optical storage device (Compact Disc (CD), Digital Versatile Disc (DVD), or the like), a storage system, a reading/writing device for recording media such as IC cards, SD cards, and optical recording media, a storage area of a cloud server, or the like. The auxiliary storage device 13 is capable of reading programs and data via a reading device for recording media and the communication device 16. The programs and data stored (memorized) in the auxiliary storage device 13 are read into the main storage device 12 as needed.

The input device 14 is an interface that receives input from the outside, which is, for example, a keyboard, a mouse, a touch panel, a card reader, a tablet supporting pen input, a voice input device, or the like.

The output device 15 is an interface that outputs various kinds of information such as processing progress and processing results. The output device 15 is, for example, a display device that visualizes the above various kinds of information (a liquid crystal monitor, a liquid crystal display (LCD), a graphic card, or the like), a device that converts the above various kinds of information into sound (a sound output device (speaker or the like)), a device that converts the above various kinds of information into text (a printing device or the like). Note that, for example, a configuration is possible in which the information processing apparatus 10 inputs or outputs information to or from other devices via the communication device 16.

The input device 14 and the output device 15 serve as user interfaces that receive or present information from or to the user.

The communication device 16 is a device that enables communication with other devices. The communication device 16 is a wired or wireless communication interface that enables communication with other devices via communication networks (the Internet, local area networks (LANs), wide area networks (WANs), dedicated lines, public communication networks, and the like), and is, for example, a network interface card (NIC), a wireless communication module, a USB module, or the like.

The information processing apparatus 10 may include, for example, an operating system, a file system, a database management system (DBMS) (a relational database, NoSQL, and the like) a key-value store (KVS), and the like.

The foregoing functions included in the named-entity classification apparatus 1 are implemented by the processor 11 reading and executing programs stored in the main storage device 12 or by hardware (an FPGA, an ASIC, an AI chip, or the like) including these devices. The named-entity classification apparatus 1 stores aforementioned various kinds of information (data), for example, in tables of databases or in files managed by file systems.

Next, a description will be given of various kinds of information managed (stored) by the named-entity classification apparatus 1.

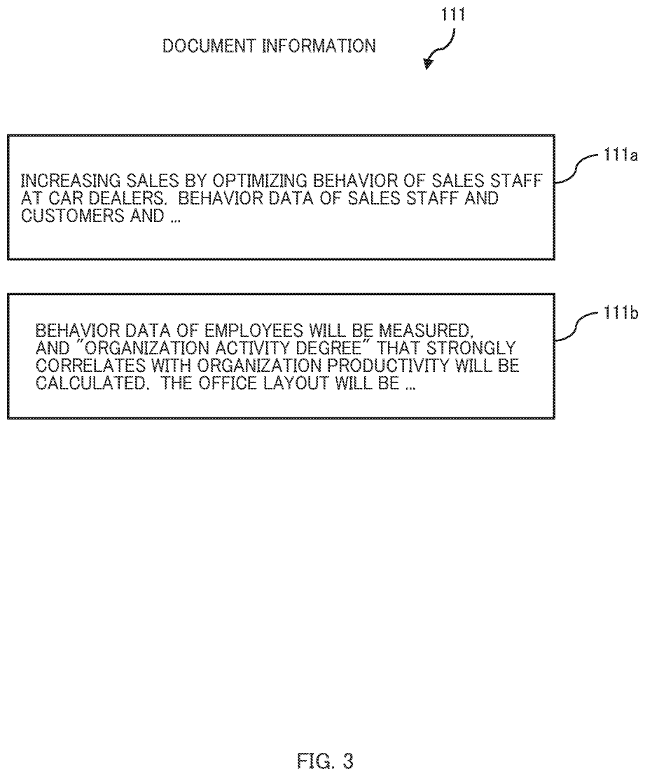

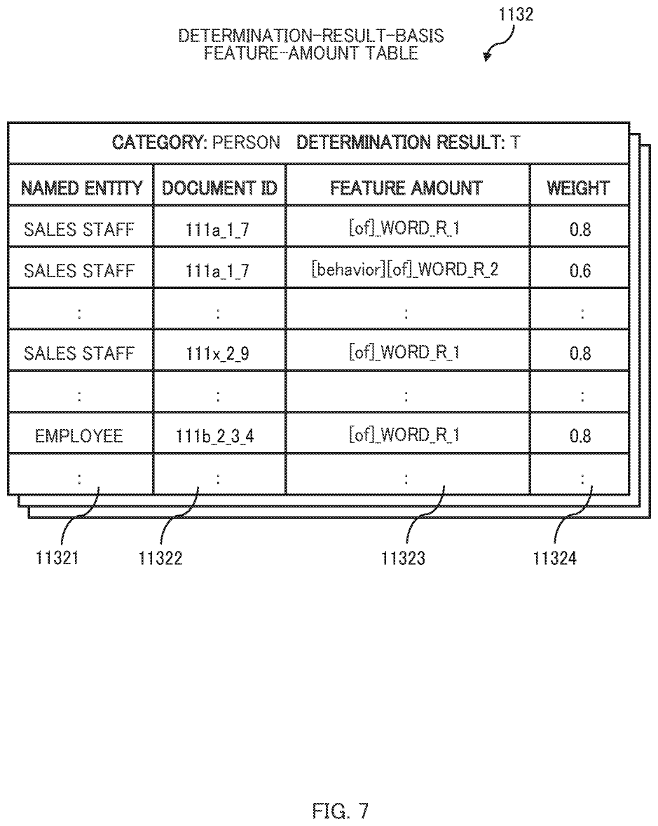

FIG. 3 shows an example of document information 111. The document information 111 in the example is internal documents in a company, stored in an information processing system of the company. The information extraction part 120 extracts, from the document information 111a and the document information 111b, named entities, for example, “car”, “dealer”, “sales staff”, “employee”, “organization”, “productivity”, “office”, and “layout” and feature amounts (for example, see FIG. 7) used when each named entity is classified into a category.

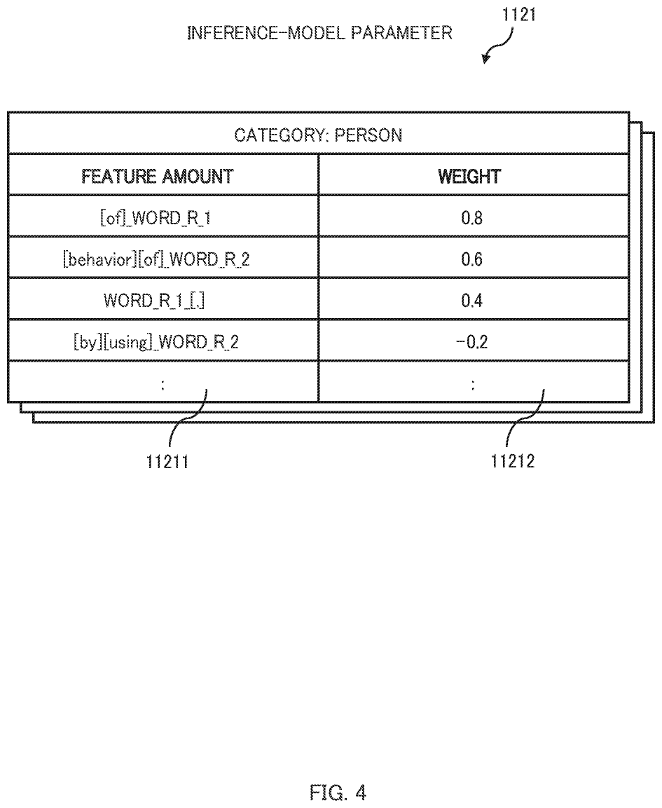

FIG. 4 shows examples of inference-model parameters 1121. The inference-model parameters 1121 include, for each category into which named entities are classified, one or more information pieces (entries (records)) in which a feature amount 1211 used when a named entity is classifies into the category is associated with a weight 11212 used for calculating the category probability of the named entity.

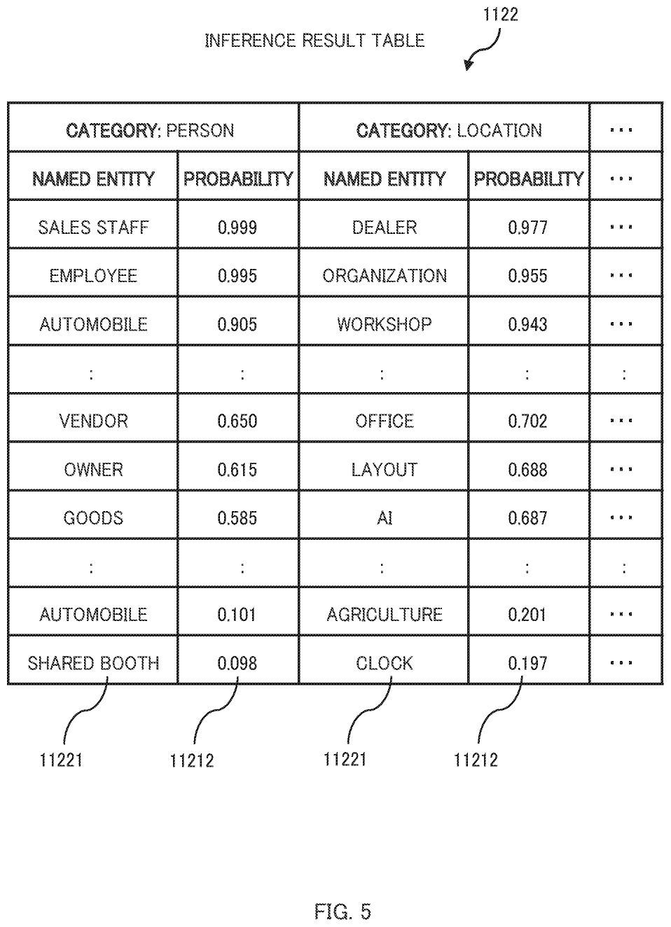

FIG. 5 illustrates an example of an inference result table 1122. The inference result table 1122 includes, for each category into which named entities are classified, one or more information pieces (entries (records)) in which a named entity 11221 is associated with the category probability 11212 indicating suitability of the named entity for the category.

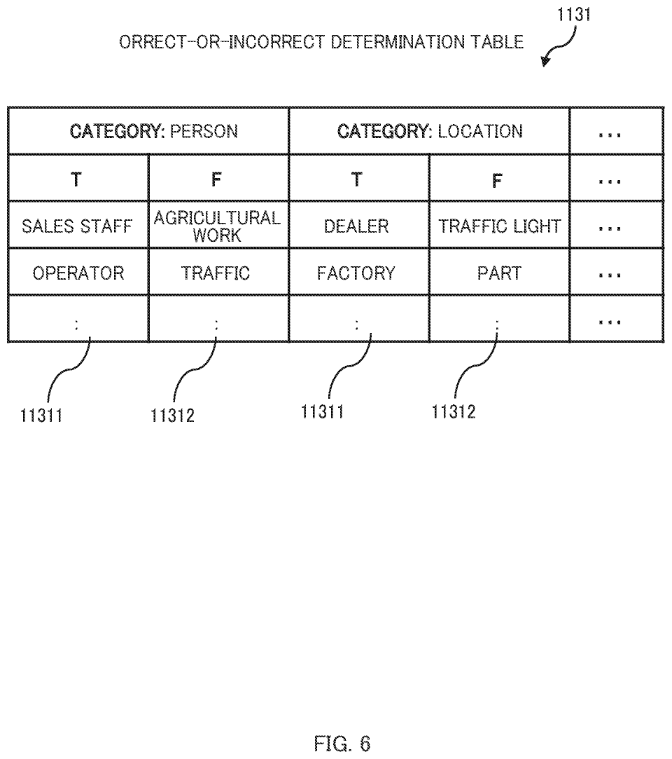

FIG. 6 illustrates an example of a correct-or-incorrect determination table 1131. The correct-or-incorrect determination table 1131 is generated by the correct-or-incorrect determination part 130 requesting the user to make a correct-or-incorrect determination for each named entity in the inference result tables 1122 and receiving correctness information from the user. The correct-or-incorrect determination table 1131 manages correctness information on each named entity for each category. In the case of the correct-or-incorrect determination table 1131 in the example, named entities determined to have been classified correctly into the category are set in the “T” column 11311, and named entities determined to have been classified incorrectly into the category are set in the “F” column 11312.

FIG. 7 illustrates an example of a determination-result-basis feature-amount table 1132. The determination-result-basis feature-amount table 1132 is generated by the feature-amount analysis part 132 based on the named-entity information 112 and the correct-or-incorrect determination table 1131. The determination-result-basis feature-amount table 1132 includes, for each result of the correct-or-incorrect determination on named entities for each category in the correct-or-incorrect determination table 1131, one or more information pieces (entries (records)) in which a named entity is associated with the document ID 11322 which is information (the identifier of the document) indicating in which document the named entity is included in the document information 111, a feature amount 11323 extracted from the document and used to classify the named entity into the category, and the weight 111324 of the feature amount.

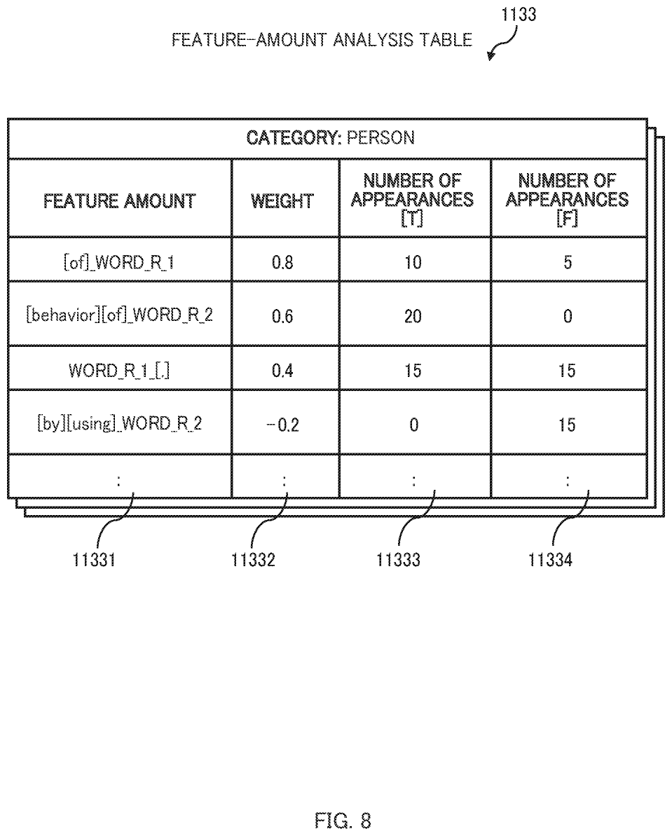

FIG. 8 illustrates an example of a feature-amount analysis table 1133. The feature-amount analysis table 1133 is generated by the feature-amount analysis part 132 based on the determination-result-basis feature-amount tables 1132. The feature-amount analysis table 1133 includes, for each category, one or more information pieces (entries (records)) in which a feature amount 11331 is associated with the weight 11332 of the feature amount, the number of appearances 11333 of the feature amount (for the case where the category classification was determined to be “T”), and the number of appearances 11334 of the feature amount (for the case where the category classification was determined to be “F”).

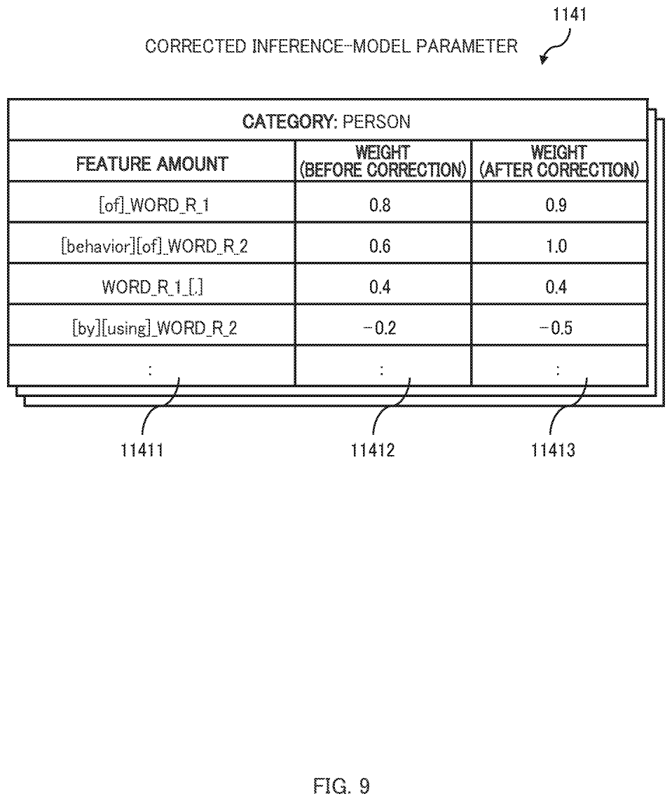

FIG. 9 shows examples of corrected inference-model parameters 1141. The corrected inference-model parameters 1141 are generated by the model correction part 140. The corrected inference-model parameters 1141 include, for each category, one or more information pieces (entries (records)) in which a feature amount 11411 is associated with the weight (before correction) 11412 which is the weight of the feature amount before correction, and the weight (after correction) 11413 which is the weight of the feature amount after correction.

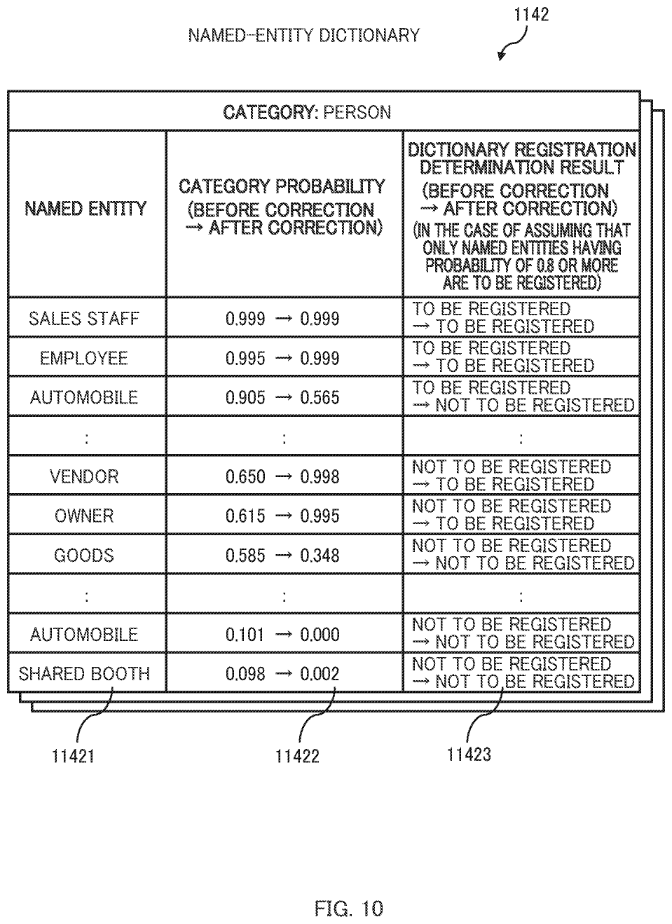

FIG. 10 shows an example of a named-entity dictionary 1142. The named-entity dictionary 1142 is generated by the dictionary generation part 150 based on the corrected inference-model parameters 1141. The named-entity dictionary 1142 includes, for each category, one or more information pieces (entries (records)) in which a named entity 11421 classified in the category is associated with the category probabilities 11422 before and after changes in the weights of the feature amounts, and the determination result 11423 indicating whether the named entity should be registered in the named-entity dictionary.

Next, description will be made of processes performed with the named-entity classification apparatus 1. Note that, it is assumed that the named-entity information 112 has been already generated before starting the following processes by the information extraction part 120 based on the document information 111. In addition, it is also assumed that each process described below is performed for each category.

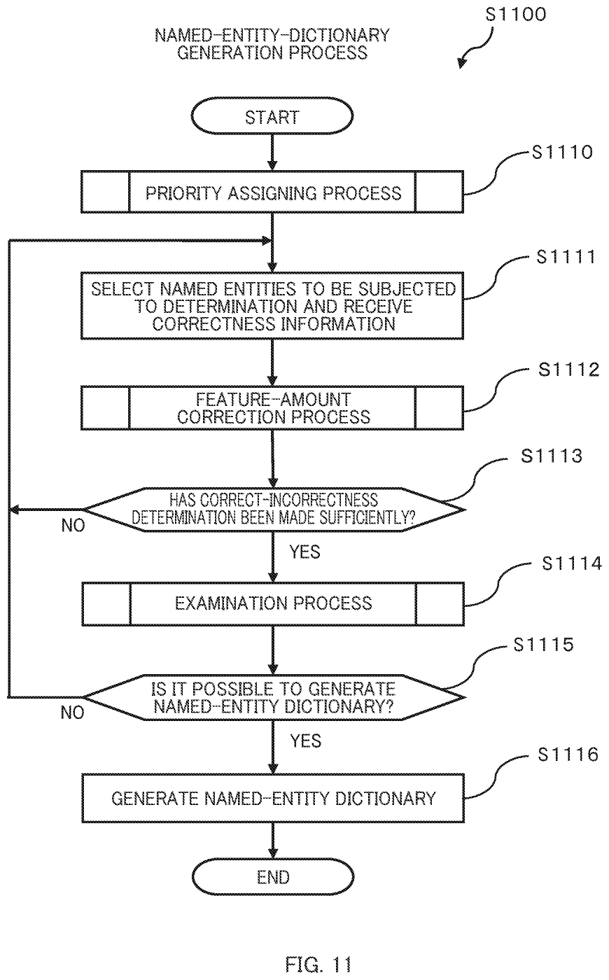

FIG. 11 is a flowchart for explaining a process performed by the named-entity classification apparatus 1 when it evaluates named entities and generates a named-entity dictionary (hereinafter referred to as a “named-entity-dictionary generation process S1100”). The named-entity-dictionary generation process S1100 starts, for example, when the named-entity classification apparatus 1 receives an execution request for an evaluation process from the user. In the following, the named-entity-dictionary generation process S1100 is described with reference to FIG. 11.

First, the correct-or-incorrect determination part 130 performs a process of assigning a priority to be used when requesting the user to input correctness information, to each named entity managed as the named-entity information 112 (hereinafter referred to as a “priority assigning process S1110”). Details of the priority assigning process S1110 will be described later.

Next, the correct-or-incorrect determination part 130 selects a specified number of unselected named entities according to the priorities assigned by the priority assigning process S1110, presents the selected named entities to the user, and receives input of correctness information from the user on the named entities (S1111).

Next, the correct-or-incorrect determination part 130 makes the received correctness information reflected on the correct-or-incorrect determination information 113, and the feature-amount correction part 141 performs a process of correcting the feature amounts based on the correct-or-incorrect determination information 113 (hereinafter referred to as a “feature-amount correction process S1112”). Details of the feature-amount correction process S1112 will be described later.

Next, the correct-or-incorrect determination part 130 determines whether “correctness information needs to be added” is set in a return value from the feature-amount correction process S1112 (S1113). If the correct-or-incorrect determination part 130 determines that “correctness information needs to be added” is not set in a return value (S1113: YES), the process proceeds to S1114 (hereinafter referred to as the “examination process S1114”). If the correct-or-incorrect determination part 130 determines that “correctness information needs to be added” is set in a return value (S1113: NO), the process returns to S1111.

In the examination process S1114, the model correction part 140 generates the probability distribution of category probabilities after the weights of feature amounts are corrected, and based on the generated probability distribution, examines whether it is possible to determine a threshold to be used in the determination whether a named entity should be adopted in the named-entity dictionary 1142. Details of the examination process S1114 will be described later.

Next, the model correction part 140 determines based on the return values from the examination process S1114 whether it is possible to generate named-entity information (corrected) 114 (S1115). If a return value from the examination process S1114 indicates that “it is possible to generate a named-entity dictionary” (S1115: YES), the process proceeds to S1116. A return value from the named-entity classification apparatus 1 indicates that “correctness information needs to be added” (S1115: NO), the process returns to S1111.

At S1116, the dictionary generation part 150 selects, out of the named entities managed as the named-entity information 112, the named entities the category probabilities of which are larger than or equal to the threshold included in a return value from the examination process S1114 and generates the named-entity dictionary 1142. Through the above process, the named-entity-dictionary generation process S1100 ends.

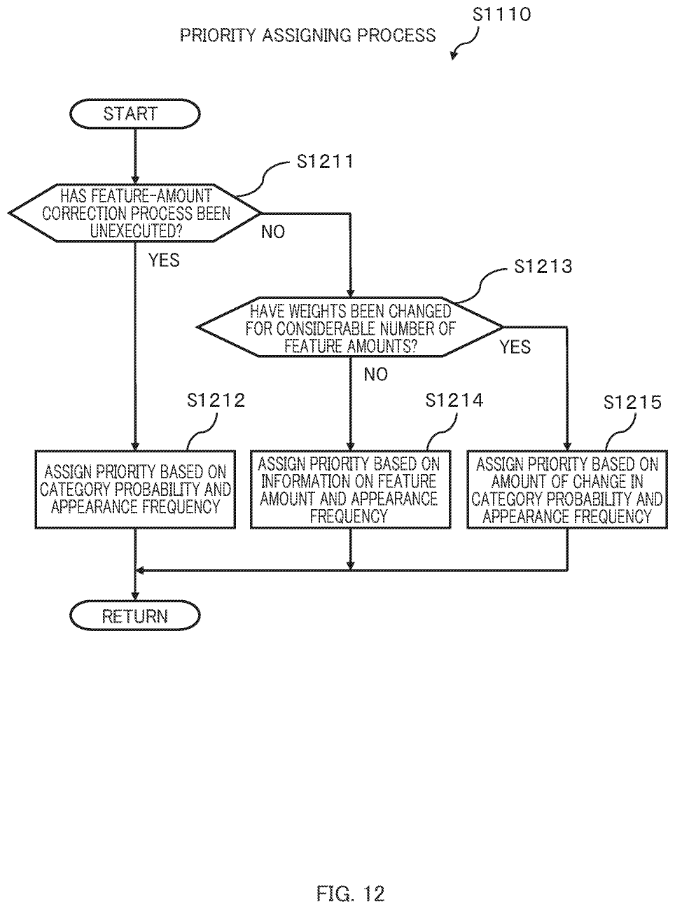

FIG. 12 is a flowchart for explaining details of the priority assigning process S1110 illustrated in FIG. 11, performed by the determination-target selection part 131. In the following, the priority assigning process S1110 will be described with reference to FIG. 12.

First, the correct-or-incorrect determination part 130 determines whether the feature-amount correction process S1112 has been unexecuted (S1211). If the correct-or-incorrect determination part 130 determines that the feature-amount correction process S1112 has been unexecuted (S1211: YES), the process proceeds to S1212. If the correct-or-incorrect determination part 130 determines that the feature-amount correction process S1112 has been executed (S1211: NO), the process proceeds to S1213.

At S1212, the correct-or-incorrect determination part 130 assigns an aforementioned priority to each named entity managed as the named-entity information 112, based on the category probabilities and the appearance frequencies. Specifically, the correct-or-incorrect determination part 130 selects the named entities the category probabilities of which are in the range of “0.45 to 0.55” (a range in which correctness is unclear), and determines the priorities of the selected named entities in descending order of the appearance frequency. As described above, since in the case where the feature-amount correction process S1112 has been unexecuted, the correct-or-incorrect determination part 130 selects the named entities in a range in which correct-or-incorrect determination is unclear and assigns priorities to the selected named entities in descending order of the appearance frequency, it is possible to present the user preferentially with named entities having high possibilities of affecting the inference accuracy of the inference model as candidates for inputting correctness information, making it possible for the user to improve the inference accuracy of the inference model efficiently.

At S1213, the correct-or-incorrect determination part 130 checks, on the changes in the feature amounts based on the user's input information, whether weights have already been changed for a sufficient number of feature amounts. Note that the correct-or-incorrect determination part 130 determines whether weights have already been changed for a sufficient number of feature amounts, based on, for example, whether the number of feature amounts the weights of which have been changed is larger than a preset number or whether the number of feature amounts the weights of which were changed is larger than the number of feature amounts the weights of which have not been changed. If the correct-or-incorrect determination part 130 determines that weights have not been changed for a considerable number of the feature amounts (S1213: NO), the process proceeds to S1214. If the correct-or-incorrect determination part 130 determines that weights have already been changed for the considerable number of the feature amounts (S1213: YES), the process proceeds to S1215.

At S1214, the correct-or-incorrect determination part 130 determines the priorities of the feature amounts of the named entities in selection based on the number of feature amounts the weights of which have not been changed yet and the number of appearances. For example, the correct-or-incorrect determination part 130 determines a priority for each named entity in descending order of the number of feature amounts the weights of which have not been changed yet. In the case where the numbers of feature amounts of named entities the weights of which have not been changed are the same, the correct-or-incorrect determination part 130 determines a priority for each named entity in descending order of the appearance frequency of the named entity in the document information 111. As described above, since in the case where the feature-amount correction process S1112 has already been executed, and weights have not yet been changed for a sufficient number of feature amounts, the correct-or-incorrect determination part 130 determines a priority for each named entity in descending order of the number of feature amounts the weights of which have not been changed, it is possible to present the user preferentially with named entities having high possibilities of improving the inference accuracy of the inference model, making it possible for the user to improve the inference accuracy of the inference model efficiently.

At S1215, the correct-or-incorrect determination part 130 determines the priorities of the named entities in selection based on the category probability and the number of appearances of each named entity. For example, the correct-or-incorrect determination part 130 determines priorities in descending order of the amount of change in category probability of the named entity when the weights of the feature amounts were changed, for both groups of the named entities the category probabilities of which changed to the positive side (the category probabilities of which increased) and the named entities the category probabilities of which changed to the negative side (the category probabilities of which decreased). In the case of named entities having the same amounts of change in category probability, the correct-or-incorrect determination part 130 determines priorities in descending order of the appearance frequency the named entity in the document information 111. In the case of named entities having the same appearance frequency, the correct-or-incorrect determination part 130 determines priorities in the order of how close the category probability before change is to “0.5”. As described above, since in the case where the feature-amount correction process S1112 has been executed, and weights already have been changed for a sufficient number of feature amounts, the correct-or-incorrect determination part 130 determines the priorities in descending order of the amount of change in category probability of the named entity when the weights of the feature amounts were changed, it is possible to present the user preferentially with named entities having high possibilities of largely changing the inference accuracy of the inference model, making it possible for the user to improve the inference accuracy of the inference model efficiently.

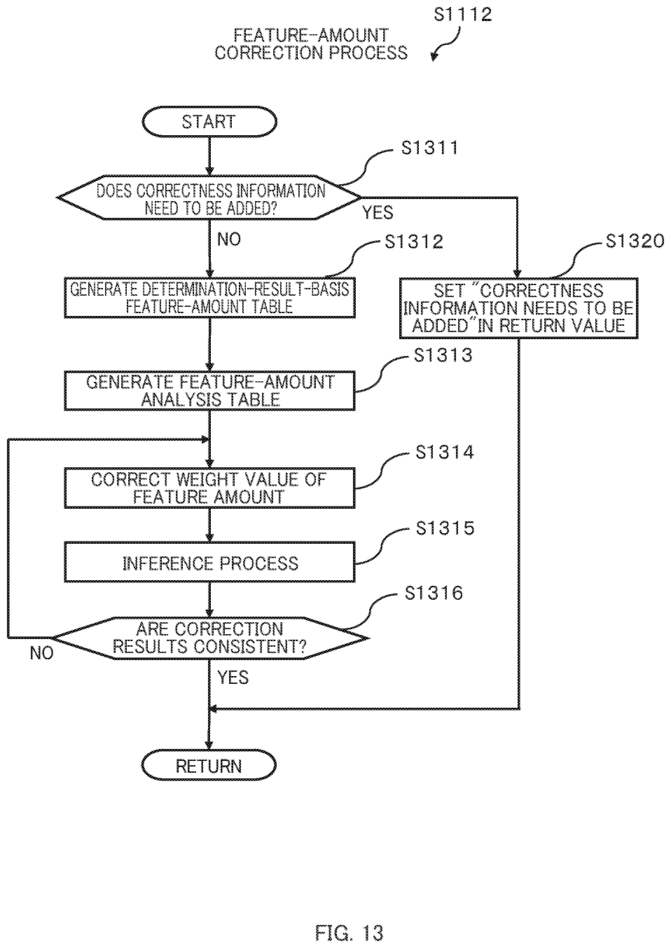

FIG. 13 is a flowchart for explaining details of the feature-amount correction process S1112 illustrated in FIG. 11, performed by the model correction part 140. In the following, the feature-amount correction process S1112 will be described with reference to FIG. 13.

First, the model correction part 140 determines based on the correct-or-incorrect determination table 1131 whether correctness information (correctness information on other named entities) needs to be added (S1311). Here, the model correction part 140 determines that correctness information needs to be added, for example, in the case where the difference between the number of named entities determined to have been classified into correct categories and the number of named entities determined to have been classified into incorrect categories is larger than a specified value (in the case where those numbers are not in balance). In addition, the model correction part 140 determines that correctness information needs to be added, for example, in the case where the number of named entities determined to have been classified into correct categories in the correct-or-incorrect determination table 1131 is zero or smaller than a preset number or in the case where the number of named entities determined to have been classified into incorrect categories in the correct-or-incorrect determination table 1131 is zero or smaller than a preset number. As described above, since the model correction part 140 determines that correctness information needs to be added in the case where there is an imbalance between the number of named entities determined to have been classified into correct categories and the number of named entities determined to have been classified into incorrect categories or in the case where these numbers are not large enough, it is possible to prevent the weights of feature amounts form being corrected in the state where the number of determined named entities is not large enough or in the state where there is an imbalance in the information, making it possible to improve the inference accuracy of the inference model. If the model correction part 140 determines that correctness information needs to be added (S1311: YES), the model correction part 140 sets “correctness information needs to be added” in a return value (S1320), and the feature-amount correction process S1112 ends. If the model correction part 140 determines that correctness information does not need to be added (S1311: NO), the process proceeds to S1312.

At S1312, the model correction part 140 generates a determination-result-basis feature-amount table 1132 (see FIG. 7) based on the named-entity information 112 and the correct-or-incorrect determination table 1131.

Next, the model correction part 140 determines the number of appearances for both groups of the named entities determined to have been classified into correct categories and the named entities determined to have been classified into incorrect categories based on the determination-result-basis feature-amount tables 1132, and generates the feature-amount analysis table 1133 (see FIG. 8) (S1313).

Next, the model correction part 140 corrects the weights of the feature amounts based on the information in the feature-amount analysis table 1133 and generates the corrected inference-model parameters 1141 (see FIG. 9) (S1314). For example, the model correction part 140 corrects the weights of feature amounts of the named entities that the user judged were classified into correct categories to higher values and corrects the weights of feature amounts of the named entities that the user judged were classified into incorrect categories to lower values.

Next, the model correction part 140 determines the category probabilities before and after correction of the feature amounts based on the corrected inference-model parameters 1141 (S1315).

Next, the model correction part 140 determines whether changes in category probability are consistent (S1316). The model correction part 140 makes the above determination, for example, based on whether the category probabilities of named entities determined to have been classified into correct categories increased (if increased, the changes are consistent, and if not, the changes are inconsistent) and whether the category probabilities of named entities determined to have been classified into incorrect categories decreased (if decreased, the changes are consistent, and if not, the changes are inconsistent). As described above, since the model correction part 140 determines whether the changes in category probabilities are consistent, it is possible to correct the weights of feature amounts appropriately so that the changes in category probabilities are consistent. If the model correction part 140 determines that the changes in category probabilities are inconsistent (S1316: NO), the process returns to S1314, and the model correction part 140 changes the weights and performs the inference process (S1315) again. If the model correction part 140 determines that the changes in category probabilities are consistent (S1316: YES), the feature-amount correction process S1112 ends. Through the above process, the feature-amount correction process S1112 ends.

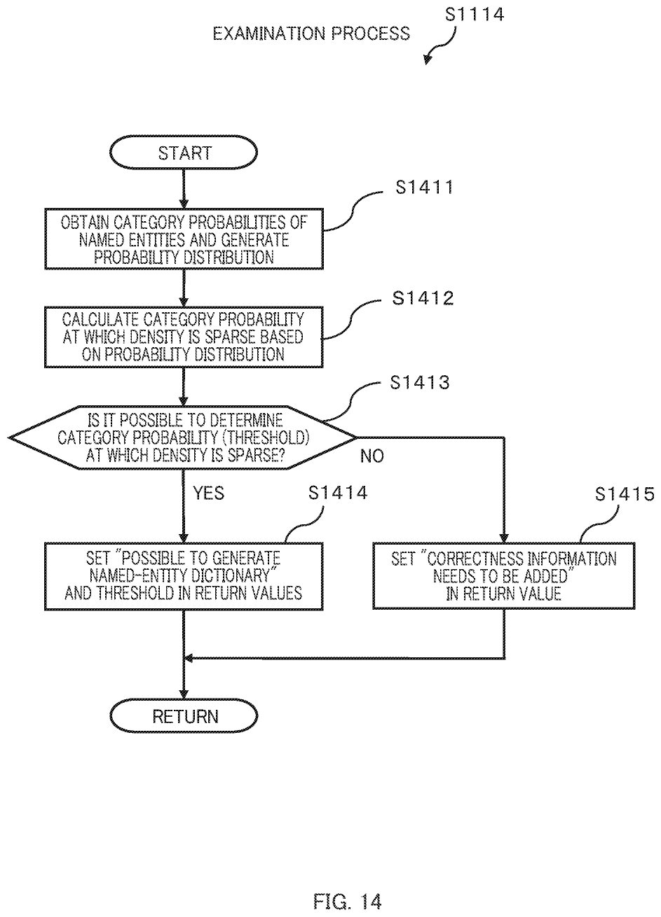

FIG. 14 is a flowchart for explaining details of the examination process S1114 illustrated in FIG. 11, performed by the model correction part 140. In the following, the examination process S1114 will be described with reference to FIG. 14.

First, the model correction part 140 obtains the category probability of each named entity determined at S1315 in the feature-amount correction process S1112 illustrated in FIG. 13 and generates the probability distribution (S1411).

Next, the model correction part 140 determines a category probability (hereinafter referred to as a “threshold”) at which the number of kinds of named entities is smallest (sparsest) in the range, “0 to 1”, of the category probability in the generated probability distribution (S1412). For example, in the case where the range of “0 to 1” that category probabilities can be in is divided into 10 regions each having a range of “0.1”, and the number of kinds of named entities the category probabilities of which are in the range of “0.6 to 0.7” is “0”, and more than 10 kinds of named entities are in each of the other ranges, the model correction part 140 will determine that the threshold case is “0.65”.

Next, the model correction part 140 determines whether the threshold was be able to be determined at S1412 (whether it is possible to determine a category probability at which the number of kinds of named entities is smaller than the number of kinds in each of the other ranges to a degree in which the difference is clear) (S1413). If the model correction part 140 determines that the threshold was able to be determined (S1413: YES), the process proceeds to S1414. If the model correction part 140 determines that the threshold was not able to be determined (S1413: NO), the process proceeds to S1415.

At S1414, the model correction part 140 sets “possible to generate a named-entity dictionary” and the threshold determined at S1412 in return values. After that, the examination process S1114 ends.

At S1415, the model correction part 140 sets “correctness information needs to be added” in a return value. After that, the examination process S1114 ends.

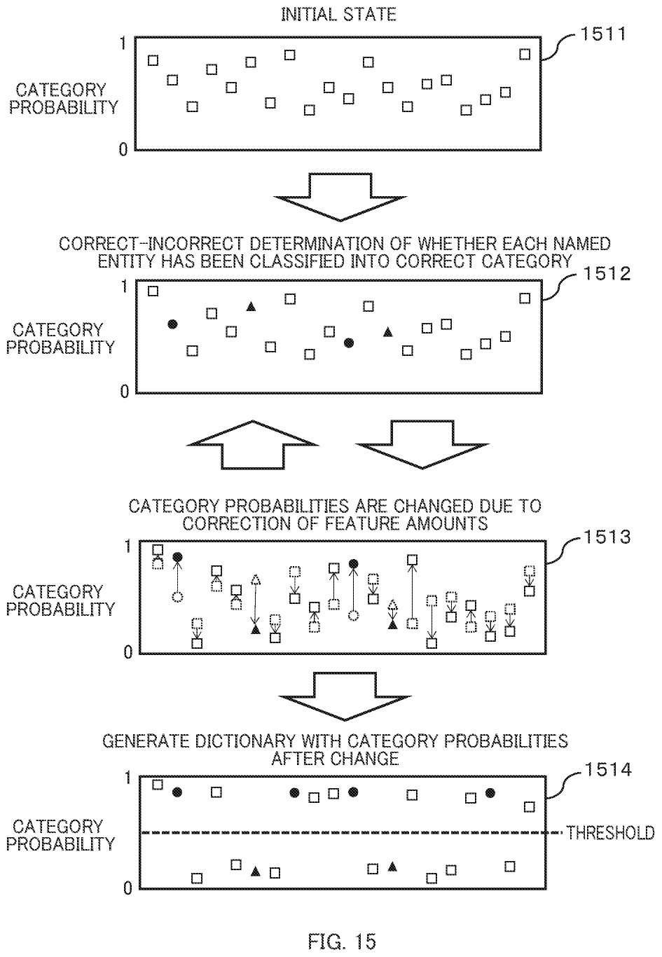

FIG. 15 is a schematic diagram for explaining details of the named-entity-dictionary generation process S1100 in FIG. 11. The four graphs 1511 to 1514 illustrated in FIG. 15 show the distributions of the category probabilities of named entities. In each of the four graphs 1511 to 1514, the vertical axis represents the category probability, and the horizontal axis indicates each named entity (for example, the identification numbers of named entities, the identifiers (document IDs) of the documents from which named entities are obtained) and the like. In the graphs 1511 to 1514, the white squares indicate named entities for which correct-or-incorrect determination has not been made (hereinafter referred to as “undetermined words”), the black dots (circles) indicate named entities determined by correct-or-incorrect determination to have been classified into correct categories, and the black triangles indicate named entities determined by correct-or-incorrect determination to have been classified into incorrect categories.

The graph 1511 illustrates the distribution of the category probabilities of named entities in the initial state. The graph 1512 shows the results of correct-or-incorrect determination performed in the process at S1111 in FIG. 11 on the graph 1511. The graph 1513 shows the named entities in the state that the weights of feature amounts have been changed in the feature-amount correction process S1112 in FIG. 13, and that inference has been executed again on the category probabilities of the named entities.

As shown in the graph 1513, the category probability of each named entity is changed by changing the weights of the feature amounts, the category probabilities of the named entities determined to have been classified into correct categories increase, and the category probabilities of the named entities determined to have been classified into incorrect categories decrease. In addition, the category probabilities of undetermined named entities having many feature amounts common to the named entities determined to have been classified into correct categories increase, and the category probabilities of undetermined named entities having many feature amounts common to the named entities determined to have been classified into incorrect categories decrease.

The graph 1514 illustrates the distribution of category probabilities after correction of the feature amounts. As described above, since correct-or-incorrect determination by the user on the category classification of named entities and correction of the feature amounts of named entities are repeatedly performed, the category probabilities of named entities that have been classified into correct categories and the category probabilities of undetermined named entities having many feature amounts common to the correctly classified named entities increase. Conversely, the category probabilities of named entities that have been classified into incorrect categories and the category probabilities of undetermined named entities having many feature amounts common to the incorrectly classified named entities decrease. In this way, the category probabilities of the named entities are clearly polarized in the end, and a category probability (threshold) at which category probabilities are sparse is identified. For example, by selecting the named entities having category probabilities larger than or equal to the identified threshold and registering them into the named-entity dictionary 1142, it is possible to efficiently achieve high accuracy in classification of named entities into categories.

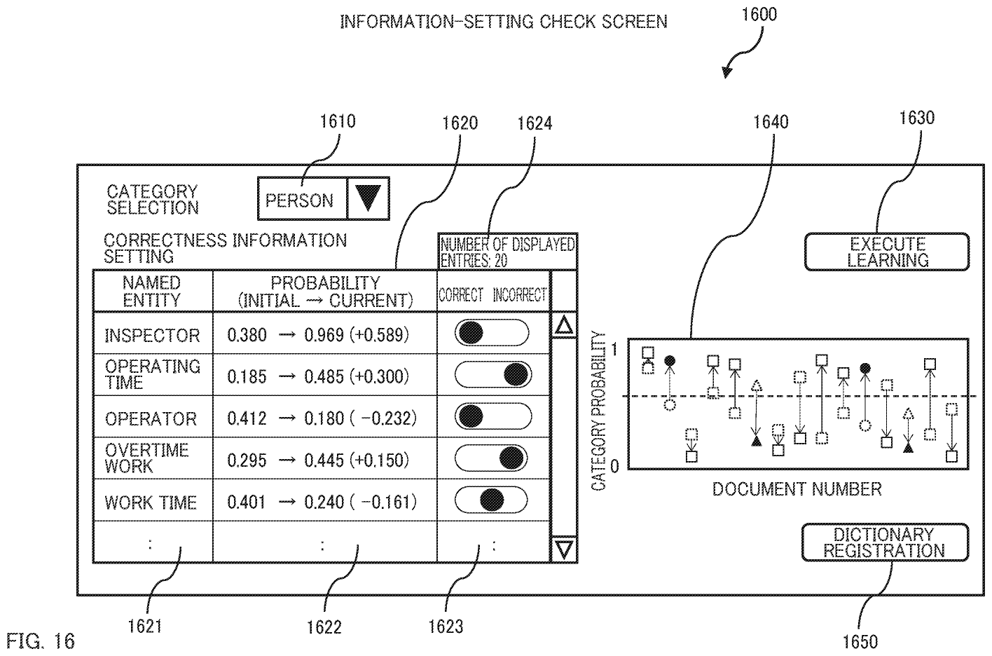

FIG. 16 shows an example of a screen (hereinafter referred to as an “information-setting check screen 1600”) presented by the named-entity classification apparatus 1 to the user via the output device 15 when the named-entity-dictionary generation process S1100 described above is executed. As illustrated in FIG. 16, the information-setting check screen 1600 includes a category selection field 1610, a correctness-information setting field 1620, a learning execution button 1630, a category-probability display field 1640, and a dictionary registration button 1650.

The category selection field 1610 is used for the user to select and set a category into which named entities are classified. In this example, a category “person” is selected.

The correctness-information setting field 1620 is used for the user to set correctness information to named entities. As illustrated in FIG. 16, the correctness-information setting field 1620 includes a plurality of entries (records) each having a named-entity display field 1621, a category-probability display field 1622, and a correctness-information setting field 1623. The correctness-information setting field 1620 also has a number-of-displayed-entries setting field 1624.

The named-entity display field 1621 displays named entities obtained from the named-entity information 112 in the order of priority (named entities for which setting of correctness information is to be received from the user). The category-probability display field 1622 displays the category probabilities of the named entity before and after aforementioned correction of the weights and the amount of the change. The correctness-information setting field 1623 is used for the user to set correctness information for the named entity (in this example, whether classification into the category “person” is correct). In this example, the user can easily set correctness information by operating a slide switch.

The number-of-displayed-entries setting field 1624 is used for the user to set the number of named entities that the user wants to be displayed. The correctness-information setting field 1620 displays as many entries of named entities as the number set in the number-of-displayed-entries setting field 1624 in the order of priority.

When the user operates the learning execution button 1630, the inference model is retrained with the weights of feature amounts after correction, and the retrained inference model is used to classify the named entities into categories.

The category-probability display field 1640 displays a graph illustrating the category probabilities before and after correction of the weight of each named entity and the amount of change. The above graph corresponds to the graph 1513 illustrated in FIG. 15.

When the user operates the dictionary registration button 1650, the dictionary generation part 150 registers the named entities having category probabilities larger than or equal to the aforementioned threshold into the named-entity dictionary 1142.

As has been described above, since the named-entity classification apparatus 1 in the present embodiment receives, from the user (SME) as feedback, correctness information indicating whether the named entities extracted from the document information have been classified into correct categories by the inference model, corrects the weights of feature amounts based on the correctness information, and retrains the inference model, the user can improve the inference accuracy of the inference model only by inputting correctness information for a necessary number of named entities. Since the weights of feature amounts are automatically adjusted, a DS does not need to be involved, and thus it is possible to classify named entities into categories efficiently and appropriately.

The order to present named entities to the user is determined based on whether correction of the feature amounts has been unexecuted, whether the weights of feature amounts have been changed, category probabilities, appearance frequencies, the amounts of changes in category probabilities caused by changing the weights of feature amounts, and other factors, and named entities are presented to the user in the determined order. Thus, it is possible to prompt the user to input correctness information for named entities in descending order of influence on the inference accuracy of the inference model, making it possible to improve the inference accuracy of the inference model efficiently.

In addition, since the weights of feature amounts are corrected in the case where there is a balance between the number of feature amounts of named entities classified into correct categories and the number of feature amounts of named entities classified into incorrect categories, it is possible to prevent biased corrections of the weights of feature amounts and prevent decrease in the inference accuracy of the inference model.

In addition, it is also possible to output an appropriate value (to present it to the user) for a threshold of the category probability used in the determination or the like whether a named entity should be registered into the named-entity dictionary. In addition, since the named-entity classification apparatus 1 requests the user to input correctness information until a significant threshold can be determined, it is possible to determine a significant threshold accurately with a minimum necessary burden.

Although an embodiment of the present invention has been described above, the present invention is not limited to the above embodiment, and it goes without saying that various kinds of modifications are possible within the range not departing from the gist of the invention. For example, although the above embodiment has been described in details in order to make the description of the present invention easier to understand, the present invention is not limited to embodiments including all the constituents described above. Some of the constituents of the above embodiment may be eliminated or replaced, or a constituent of another configuration may be added to the above embodiment.

Some or all of the constituents, functional units, processing units, processing means described above may be implemented using hardware, for example, by designing those in an integrated circuit. Alternatively, each constituent, function, and the like described above may be implemented in software, and a processor may interpret and execute a program that provides each function. Information such as programs, tables, and files for providing functions can be stored in a recording device such as memory, a hard disk, or a solid state drive (SSD) or a recording medium such as an IC card, an SD card, or a DVD.

In addition, the arrangement of various functional units, various processing units, and various databases in each information processing apparatus described above is a mere example. The arrangement of various functional units, various processing units, and various databases can be changed to the optimum one from the viewpoints of the performance, process efficiency, communication efficiency, and the like of hardware or software included in these devices.

In addition, the configurations (for example, schema) of databases that store aforementioned various kinds of data can be flexibly changed from the viewpoints of the efficiency of resource usage, improvement in process efficiency, improvement in access efficiency, improvement in search efficiency, and other factors.

What is claimed is:

1. A named-entity classification apparatus comprising
an information processing apparatus, the named-entity classification apparatus configured to
classify a plurality of named entities extracted from document information into categories by using an inference model,
receive, from a user, input of correctness information indicating whether each of the named entities has been classified into a category correctly,
correct weights of feature amounts that the inference model uses in the classification based on the received correctness information, and
retrain the inference model based on the weights after the correction.

2. The named-entity classification apparatus according to claim 1, wherein
the inference model determines, for the classification, a probability indicating suitability of each of the named entities for the category, and
the named-entity classification apparatus presents the user with the named entities, while prioritizing named entities of the named entities the probabilities of which have been largely changed when the weights of the feature amounts were corrected, and receives input of the correctness information.

3. The named-entity classification apparatus according to claim 1, wherein
the inference model determines, for the classification, a probability indicating suitability of each of the named entities for the category, and
the named-entity classification apparatus presents the user with the named entities, while prioritizing named entities of the named entities the probabilities of which are large, and receives input of the correctness information.

4. The named-entity classification apparatus according to claim 1, wherein,
the inference model presents the user with the named entities, while prioritizing named entities of the named entities having a large number of the feature amounts the weights of which have not been changed, and receives input of the correctness information.

5. The named-entity classification apparatus according to claim 1, wherein,
the named-entity classification apparatus receives, from the user, setting of the number of named entities of the named entities to be displayed, and presents the user with as many of the named entities as the received number.

6. The named-entity classification apparatus according to claim 1, wherein,
in a case where the difference between the number of named entities of the named entities determined to have been classified into the categories correctly and the number of named entities of the named entities determined to have been classified incorrectly is larger than a specified value, the named-entity classification apparatus requests the user to input the correctness information for others of the named entities.

7. The named-entity classification apparatus according to claim 1, wherein,
in a case where the number of named entities of the named entities determined to have been classified into the categories correctly is not larger than a preset number, or in a case where the number of named entities of the named entities determined to have been classified incorrectly is not larger than a preset number, the named-entity classification apparatus requests the user to input the correctness information for others of the named entities.

8. The named-entity classification apparatus according to claim 1, wherein,
the inference model determines, for the classification, a probability indicating suitability of each of the named entities for the category, and
the named-entity classification apparatus
determines probability distribution based on the plurality of named entities,
identifies a probability at which density is sparsest in the probability distribution, and
outputs the identified probability.

9. The named-entity classification apparatus according to claim 8, wherein,
the named-entity classification apparatus generates a graph indicating the probability distribution for before and after correction of the weights and a screen showing the identified probability, and presents the graph and the screen to the user.

10. The named-entity classification apparatus according to claim 1, wherein,
the named-entity classification apparatus generates a dictionary including information in which each of the named entities is associated with a category in which the named entity is classified.

11. A named-entity classification method executed by an information processing apparatus comprising:
classifying a plurality of named entities extracted from document information into categories by using an inference model;
receiving, from a user, input of correctness information indicating whether each of the named entities has been classified into a category correctly;
correcting weights of feature amounts that the inference model uses in the classification based on the received correctness information; and
retraining the inference model based on the weights after the correction.

12. The named-entity classification method according to claim 11, further comprising:
determining, for the classification, a probability indicating suitability of each of the named entities for the category, by using the inference model; and
presenting the user with the named entities, while prioritizing named entities of the named entities the probabilities of which have been largely changed when the weights of the feature amounts were corrected to receive input of the correctness information.

13. The named-entity classification method according to claim 11, further comprising
in a case where the difference between the number of named entities of the named entities determined to have been classified into the categories correctly and the number of named entities of the named entities determined to have been classified incorrectly is larger than a specified value, requesting the user to input the correctness information for others of the named entities.

14. The named-entity classification method according to claim 11, further comprising:
determining, for the classification, a probability indicating suitability of each of the named entities for the category, by using the inference model;
determining probability distribution based on the plurality of named entities;
identifying a probability at which density is sparsest in the probability distribution; and
outputting the identified probability, wherein
the determining of the probability.

15. The named-entity classification method according to claim 11, further comprising
generating a dictionary including information in which each of the named entities is associated with a category in which the named entity is classified.
